(19) United States
(12) Patent Application Publication
(10) Pub. No.: US 2025/0056660 A1
(43) Pub. Date: Feb. 13, 2025

(54) COLLISION HANDLING FOR INTERRUPTIONS AND DISCONTINUOUS RECEPTION OPERATION

(71) Applicant: Nokia Technologies Oy, Espoo (FI)

(72) Inventors: Rafael CAUDURO DIAS DE PAIVA, Aalborg (DK); Bent Henneberg RYSGAARD, Aalborg (DK); Jürgen HOFMANN, Merching (DE)

(21) Appl. No.: 18/798,827

(22) Filed: Aug. 9, 2024

Related U.S. Application Data
(60) Provisional application No. 63/518,950, filed on Aug. 11, 2023.
(60) Provisional application No. 63/551,260, filed on Feb. 8, 2024.

(51) Int. Cl. H04W 76/28; H04W 92/18

(52) U.S. Cl. CPC H04W 76/28; H04W 92/18

(57) ABSTRACT

A method comprising: determine, at a first apparatus, at least one of: that a condition related to a communication interruption and a discontinuous reception, DRX, operation for the first apparatus is fulfilled, or that a first indication to handle a collision between the communication interruption and the DRX operation is received from a second apparatus; and based on the determining the at least one of that the condition is fulfilled or that the first indication is received, shift the communication interruption in time domain.

### FIELDS

Various example embodiments of the present disclosure generally relate to the field of telecommunication and in particular, to methods, devices, apparatuses and computer readable storage medium for collision handling for interruptions and discontinuous reception (DRX) operation.

### BACKGROUND

With developments of communication technologies, a technology named “discontinuous reception (DRX)” has been proposed in order to save power. DRX is a technique that allows a User Equipment (UE) to turn off its transceiver for a major duration of a DRX cycle when there are no packets to be received.

In another aspect, the UE has to measure the neighboring cell signal and other carrier components. There are UEs that support performing measurements without gaps, but need interruptions. In some cases, a collision between the interruptions and DRX operation may occur.

### SUMMARY

In a first aspect of the present disclosure, there is provided a first apparatus. The first apparatus comprises at least one processor; and at least one memory storing instructions that, when executed by the at least one processor, cause the first apparatus to: determine at least one of: that a condition related to a communication interruption and a discontinuous reception, DRX, operation for the first apparatus is fulfilled, or that a first indication to handle a collision between the communication interruption and the DRX operation is received from a second apparatus; and based on the determining the at least one of that the condition is fulfilled or that the first indication is received, shift the communication interruption in time domain.

In a second aspect of the present disclosure, there is provided a second apparatus. The second apparatus comprises at least one processor; and at least one memory storing instructions that, when executed by the at least one processor, cause the second apparatus to: receive, from a first apparatus, capability information indicating a capability of the first apparatus for collision handling associated with measurement gaps and control channel transmissions; determine that a condition related to a communication interruption and a discontinuous reception, DRX, operation for the first apparatus is fulfilled; and based on the determining that the condition is fulfilled, transmit, to the first apparatus a first indication to handle a collision between the communication interruption and the DRX operation.

In a third aspect of the present disclosure, there is provided a method. The method comprises: determining, at a first apparatus, at least one of: that a condition related to a communication interruption and a discontinuous reception, DRX, operation for the first apparatus is fulfilled, or that a first indication to handle a collision between the communication interruption and the DRX operation is received from a second apparatus; and based on the determining the at least one of that the condition is fulfilled or that the first indication is received, shifting the communication interruption in time domain.

In a fourth aspect of the present disclosure, there is provided a method. The method comprises: receiving, at a second apparatus, from a first apparatus, capability information indicating a capability of the first apparatus for collision handling associated with measurement gaps and control channel transmissions; determining that a condition related to a communication interruption and a discontinuous reception, DRX, operation for the first apparatus is fulfilled; and based on the determining that the condition is fulfilled, transmitting, to the first apparatus a first indication to handle a collision between the communication interruption and the DRX operation.

In a fifth aspect of the present disclosure, there is provided a first apparatus. The first apparatus comprises means for determining at least one of: that a condition related to a communication interruption and a discontinuous reception, DRX, operation for the first apparatus is fulfilled, or that a first indication to handle a collision between the communication interruption and the DRX operation is received from a second apparatus; and means for, based on the determining the at least one of that the condition is fulfilled or that the first indication is received, shifting the communication interruption in time domain.

In a sixth aspect of the present disclosure, there is provided a second apparatus. The second apparatus comprises means for receiving, from a first apparatus, capability information indicating a capability of the first apparatus for collision handling associated with measurement gaps and control channel transmissions; means for determining that a condition related to a communication interruption and a discontinuous reception, DRX, operation for the first apparatus is fulfilled; and means for, based on the determining that the condition is fulfilled, transmitting, to the first apparatus a first indication to handle a collision between the communication interruption and the DRX operation.

In a seventh aspect of the present disclosure, there is provided a computer readable medium. The computer readable medium comprises instructions stored thereon for causing an apparatus to perform at least the method according to the third aspect.

In an eighth aspect of the present disclosure, there is provided a computer readable medium. The computer readable medium comprises instructions stored thereon for causing an apparatus to perform at least the method according to the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a schematic diagram of a DRX operation;

FIG. 3A illustrates a schematic diagram of measurements performed by a UE with gaps;

FIG. 3B illustrates a schematic diagram of a network control small gap (NCSG) or measurements without gaps;

FIG. 4 illustrates a signaling flow for signaling support for NCSG;

FIG. 5 illustrates a schematic diagram of collisions between interruptions and a DRX operation;

FIG. 6 illustrates a signaling flow for collision handing for interruptions and a DRX operation according to some example embodiments of the present disclosure;

FIG. 7 illustrates a schematic diagram of a result of collision handling according to some example embodiments of the present disclosure;

FIG. 8 illustrates a signaling flow for configuring collision handling according to some example embodiments of the present disclosure;

FIG. 9 illustrates a flowchart of a method implemented at a first device according to some example embodiments of the present disclosure;

FIG. 10 illustrates a flowchart of a method implemented at a second device according to some example embodiments of the present disclosure;

FIG. 11 illustrates a simplified block diagram of a device that is suitable for implementing example embodiments of the present disclosure; and

FIG. 12 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (is) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As used herein, the expression “shift a communication interruption forward in time domain” means to shift the start of the communication interruption to an earlier time point. Similarly, the expression “shift a communication interruption backward in time domain” means to shift the start of the communication interruption to a later time point.

### Example Environment

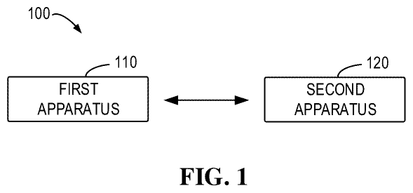

FIG. 1 illustrates an example communication environment 100 in which example embodiments of the present disclosure can be implemented. As shown in FIG. 1, the communication environment 100 may include a first apparatus 110 and a second apparatus 120. The first apparatus 110 may communicate with the second apparatus 120.

It is to be understood that the number of second apparatus and first apparatus shown in FIG. 1 is given for the purpose of illustration without suggesting any limitations. The communication network 100 may include any suitable number of second apparatus and first apparatus.

In some example embodiments, the first apparatus 110 may comprise a terminal device (for example, a UE), and the second apparatus 120 may comprise a network device (for example, a gNB). If the first apparatus 110 is a UE, the model at the UE may be also referred to as a UE side model.

In the following, for the purpose of illustration, some example embodiments are described with the first apparatus 110 operating as a terminal device (for example, UE) and the second apparatus 120 operating as a network device (for example, a gNB). However, in some example embodiments, operations described in connection with a terminal device may be implemented at a network device or other device, and operations described in connection with a network device may be implemented at a terminal device or other device.

In some example embodiments, if the first apparatus 110 is a terminal device and the second apparatus 120 is a network device, a link from the second apparatus 120 to the first apparatus 110 is referred to as a downlink (DL), and a link from the first apparatus 110 to the second apparatus 120 is referred to as an uplink (UL). In DL, the second apparatus 120 is a transmitting (TX) device (or a transmitter) and the first apparatus 110 is a receiving (RX) device (or a receiver). In UL, the first apparatus 110 is a TX device (or a transmitter) and the second apparatus 120 is a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

In communication, the second apparatus 120 may perform control channel transmissions with the first apparatus, for example, physical downlink control channel (PDCCH) transmission. The first apparatus 110 may be configured to perform DRX for the control channel transmission.

As an example, a DRX configuration (for example connected mode DRX) of the UE is listed as below in Table 1.

TABLE 1
-- ASN1START
-- TAG-DRX-CONFIG-START

| | |
|---|---|
| DRX-Config ::= | SEQUENCE { |

| | |
|---|---|
| drx-onDuration Timer | CHOICE { |

subMilliSeconds INTEGER (1..31),
milliSeconds ENUMERATED {

ms1, ms2, ms3, ms4, ms5, ms6, ms8, ms10, ms20, ms30, ms40, ms50, ms60,
ms80, ms100, ms200, ms300, ms400, ms500, ms600, ms800, ms1000, ms1200,
ms1600, spare8, spare7, spare6, spare5, spare4, spare3, spare2, spare1 }

},

| | |
|---|---|
| drx-InactivityTimer | ENUMERATED { |

ms0, ms1, ms2, ms3, ms4, ms5, ms6, ms8, ms10, ms20, ms30, ms40, ms50, ms60, ms80,
ms100, ms200, ms300, ms500, ms750, ms1280, ms1920, ms2560, spare9, spare8,
spare7, spare6, spare5, spare4, spare3, spare2, spare1},

| | |
|---|---|
| drx-HARQ-RTT-TimerDL | INTEGER (0..56), |
| drx-HARQ-RTT-TimerUL | INTEGER (0..56), |

| | |
|---|---|
| drx-RetransmissionTimerDL | ENUMERATED { |

sl0, sl1, sl2, sl4, sl6, sl8, sl16, sl24, sl33, sl40, sl64, sl80, sl96, sl112, sl128,
sl160, sl320, spare15, spare14, spare13, spare12, spare11, spare 10, spare9,
spare8, spare7, spare6, spare5, spare4, spare3, spare2, spare1},

| | |
|---|---|
| drx-RetransmissionTimerUL | ENUMERATED { |

sl0, sl1, sl2, sl4, sl6, sl8, sl16, sl24, sl33, sl40, sl64, sl80, sl96, sl112, sl128,
sl160, sl320, spare15, spare14, spare13, spare12, spare11, spare10, spare9,
spare8, spare7, spare6, spare5, spare4, spare3, spare2, spare1 },

| | |
|---|---|
| drx-LongCycleStartOffset | CHOICE { |

| | |
|---|---|
| ms10 | INTEGER(0..9), |
| ms20 | INTEGER(0..19), |
| ms32 | INTEGER(0..31), |
| ms40 | INTEGER(0..39), |
| ms60 | INTEGER(0..59), |
| ms64 | INTEGER(0..63), |
| ms70 | INTEGER(0..69), |
| ms80 | INTEGER(0..79), |
| ms128 | INTEGER(0..127), |
| ms160 | INTEGER(0..159), |
| ms256 | INTEGER(0..255), |
| ms320 | INTEGER(0.319), |
| ms512 | INTEGER(0..511), |
| ms640 | INTEGER(0..639), |
| ms1024 | INTEGER(0..1023), |
| ms1280 | INTEGER(0..1279), |
| ms2048 | INTEGER(0.2047), |
| ms2560 | INTEGER(0..2559), |
| ms5120 | INTEGER(0.5119), |
| ms10240 | INTEGER(0..10239) |

},

| | |
|---|---|
| shortDRX | SEQUENCE { |

| | |
|---|---|
| drx-ShortCycle | ENUMERATED { |

ms2, ms3, ms4, ms5, ms6, ms7, ms8, ms10, ms14, ms16, ms20, ms30, ms32,
ms35, ms40, ms64, ms80, ms128, ms160, ms256, ms320, ms512, ms640, spare9,
spare8, spare7, spare6, spare5, spare4, spare3, spare2, spare1 },

| | |
|---|---|
| drx-ShortCycle Timer | INTEGER (1..16) |

| | |
|---|---|
| } | OPTIONAL, -- Need R |

| | |
|---|---|
| drx-SlotOffset | INTEGER (0..31) |

}

| | |
|---|---|
| DRX-ConfigExt-v1700 ::= | SEQUENCE { |

| | |
|---|---|
| drx-HARQ-RTT-TimerDL-r17 | INTEGER (0..448), |
| drx-HARQ-RTT-TimerUL-r17 | INTEGER (0..448) |

}
-- TAG-DRX-CONFIG-STOP
-- ASN1STOP

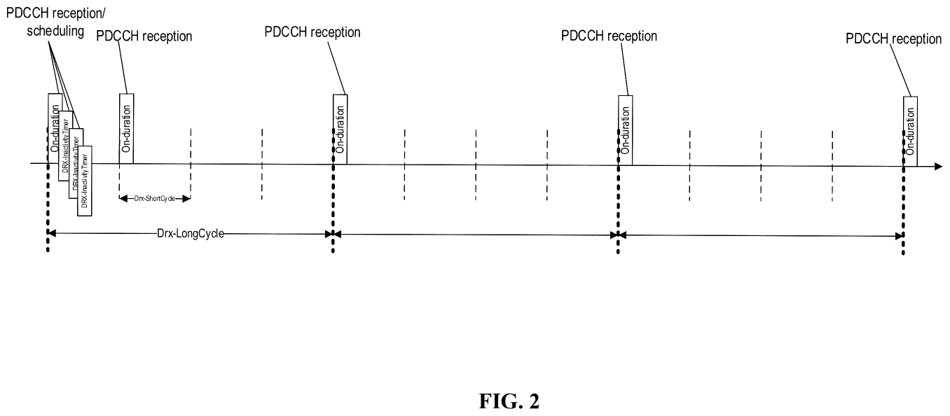

The usage of some of the parameters in Table 1 is now described with reference to FIG. 2. The UE listens to the PDCCH every long DRX long cycle for the duration of the on-duration time period, which corresponds to the parameter “drx-onDurationTimer”. The on-duration time period may hold one or more PDCCH occasions.

If the UE is scheduled during the on-duration time period, the in-activity timer (corresponding to the parameter “drx-InactivityTimer”) is started. The UE will continue to monitor the PDCCH during the time period the in-activity timer is running. If the UE is scheduled during the running of the in-activity timer, the in-activity timer is re-started. For example, as shown in FIG. 2, the on duration time period is extended by three time periods defined by respective in-activity timers.

If the UE is configured with short DRX cycles as well as long DRX cycles and if the UE has been scheduled in an on-duration time period of a long DRX cycle, the UE will also monitor the on-duration time period defined by the short DRX cycle on-duration. More than one short DRX periods may be defined for each long DRX cycle, the number of periods is part of the DRX configuration.

If the UE receives PDCCH indicating a new transmission either in DL or UL it will start a drx-InactivityTimer in the next symbol after the end of the PDCCH reception. While this timer is running, the UE is active. If the UE receives further PDCCH while this timer is running, the drx-InactivityTimer is restarted and the Active duration is further extended while the timer is running.

If the UE is configured with the DRX-retransmissiontimerDL timer, the UE can monitor PDCCH for this timer's duration when a DL re-transmission is expected by the UE. When a new DL transmission is received by the UE, it can start the DRX-HARQ-RTT-TimerDL in the immediate first symbol after transmitting NACK in the UL. Once the DRX-HARQ-RTT-TimerDL timer is expired, the UE starts the DRX-RetransmissionTimerDL timer in the next symbol and becomes active for the duration of this timer. As soon as the UE detects a DL transmission for the corresponding HARQ process, it may stop the timer DRX-RetransmissionTimerDL.

Timer drx-HARQ-RTT-TimerUL defines how long after a transmission, the UE can expect a grant for uplink re-transmission. The DRX-RetransmissionTimerUL timer indicates a maximum number of slots for which the UE should be monitoring PDCCH when a grant for uplink re-transmission is expected by the UE.

The UE is active and may receive a grant for DL or UL while either the timer DRX-RetransmissionTimerDL or DRX-RetransmissionTimerUL are running. As a result, similar to the in-activity timer shown in FIG. 2, a scheduled on-duration time period may be extended with the active time provided by the running DRX-RetransmissionTimerDL or DRX-RetransmissionTimerUL timers.

In another aspect, as mentioned above, regarding measurements of the UE, there are 3 gap types: Pre-configured MG (Pre-MG), Concurrent MG and NCSG.

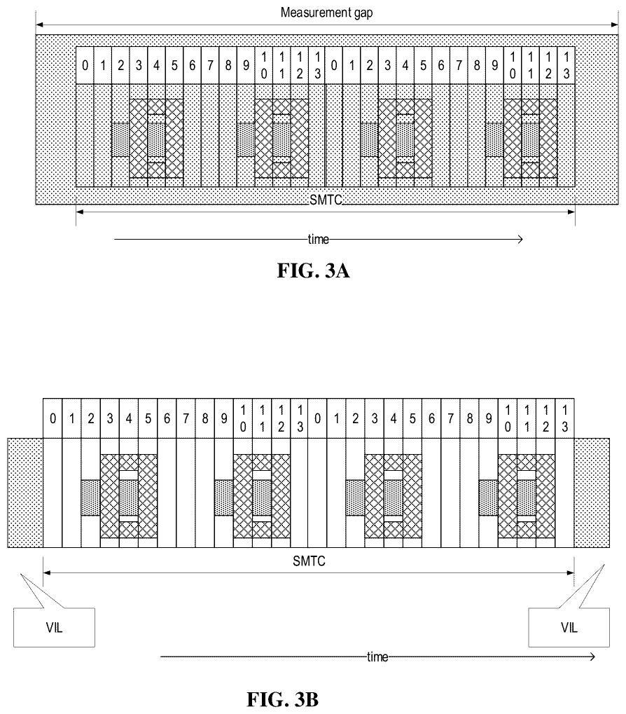

Measurement with gaps (for example, Pre-MG, Concurrent MG) are performed when the gNB configures a measurement gap pattern (MGP) for the UE to perform measurements on serving carrier (intra-frequency measurements) or non-serving carrier (inter-frequency measurements), as shown in FIG. 3A. Measurement gaps are configured by the gNB based on the UE indication on the need for measurement gaps. Gaps can be defined as a time window in which the UE is not expected to receive from nor transmit to the network, including PDCCH, physical downlink shared channel (PDSCH), physical uplink control channel (PUCCH), physical uplink shared channel (PUSCH) and reference signals such as PRS and SRS. The measurement gaps are configured by RRC. The configuration of a measurement gap, the MGP, includes the measurement gap repetition period, the measurement gap length, the gap offset and the measurement gap timing advance. Measurement gap length can be as short as 1.5 ms or as long as 20 ms, and the gap repetition period can be as short as 20 ms and as long as 160 ms. As an example, if the UE is performing synchronization signal block (SSB) based L3 measurements, a typical SSB-burst length would be 5 ms, with a repetition of about 20 ms, and the network can configure a gap of 5.5 ms length with 80 ms repetition to match the fourth successive occurrence of that SSB-burst. Hence, a measurement gap has to cover the SSBs to be measured in the SSB burst but does not necessarily have to cover all available SSBs of that SSB burst. FIG. 3A shows an example SSB Measurement Timing Configuration (SMTC).

The UE may also perform measurements with NCSG, as shown in FIG. 3B. NCSGs were developed to consider the UE that has a spare RF chain which can be used for measurements on given target carrier(s). During the measurement window (ML), the UE configured with NCSG can be scheduled in the serving cell to receive DL data or transmit UL data, while there is scheduling restriction in two small gaps before and after the measurement window (ML) covering the SMTC window, and these two small gaps are called visible interruption length (VIL). VIL may be 1 ms for FR1 and 0.75 ms for FR2.

In some mechanisms, signaling associated with those 3 types of gaps may include RRC configuration and response messages.

In Release 16, the feature needForGaps was introduced for NR. One way that this feature can be configured, is during the RRCReconfiguration procedure. The network (NW) sends an RRCReconfiguration message including the Information Element (IE) “needForGapsConfigNR”, which includes the NR bands for which the UE is requested to report the gap information. In response, the UE sends a RRCReconfigurationComplete message including IE “needForGapsInfoNR”, which includes the list of Intra-Frequency cells for which a measurement gap is needed. The UE indicates that information including the gapIndication-r16 to indicate whether “gap” or “no-gap” is required. It also includes the list of inter-frequency bands for which a measurement gap is needed. In addition to the feature “needForGaps”, in Rel-17 the feature needForNCSG was introduced in a similar manner, in which the UE indicates the need of NCSG gaps. In the case of NCSG, the UE includes additional information as part of the needForNCSG IE indicating “gap”, “ncsg”, “nogap-noncsg”.

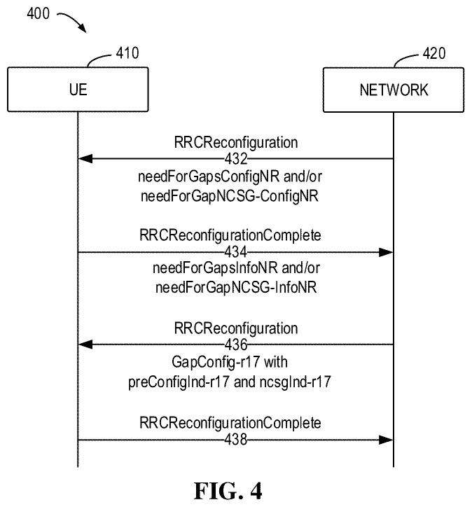

FIG. 4 depicts the signaling flow 400 for Rel-17 signalling of gap/NCSG support. The network 420 sends (432) an RRCReconfiguration message including the IE “needForGapsConfigNR” and/or “needForGapNCSG-ConfigNR”. In response, the UE 410 sends (434) a RRCReconfigurationComplete message including IE “needForGapsInfoNR” and/or “needForGapNCSG-InfoNR”. Then, the network 420 sends (436) an RRCReconfiguration message including the IE GapConfig-r17 with preConfigInd-r17 and ncsgInd-r17. In response, the UE 410 sends (438) a RRCReconfigurationComplete message.

The relevant parameters related to the diagram in FIG. 4 are shown for information below.

The IE NeedForGapsConfigNR contains configuration related to the reporting of measurement gap requirement information. Table 2 shows the IE needForGapsConfigNR.

TABLE 2
NeedForGapsConfigNR information element

```
-- ASN1START
-- TAG-NeedForGapsConfigNR-START
NeedForGapsConfigNR-r16 ::= SEQUENCE {
  requestedTargetBandFilterNR-r16 SEQUENCE (SIZE (1..maxBands)) OF
  FreqBandIndicatorNR OPTIONAL -- Need R
}
-- TAG-NeedForGapsConfigNR-STOP
-- ASN1STOP
```

The IE NeedForGapsInfoNR indicates whether measurement gap is required for the UE to perform SSB based measurements on an NR target band while NR-dual connectivity (DC) or NR-E-UTRA (NE)-DC is not configured. Table 3 shows the IE NeedForGapsInfoNR.

TABLE 3
NeedForGapsInfoNR information element

```
-- ASN1START
-- TAG-NeedForGapsInfoNR-START
NeedForGapsInfoNR-r16 ::= SEQUENCE {
  intraFreq-needForGap-r16 NeedForGapsIntraFreqList-r16,
  interFreq-needForGap-r16 NeedForGapsBandListNR-r16
}
NeedForGapsIntraFreqList-r16 ::= SEQUENCE (SIZE (1.. maxNrofServingCells)) OF
    NeedForGapsIntraFreq-r16
NeedForGapsBandListNR-r16 ::= SEQUENCE (SIZE (1..maxBands)) OF
    NeedForGapsNR-r16
NeedForGapsIntraFreq-r16 ::= SEQUENCE {
  servCellId-r16 ServCellIndex,
  gapIndicationIntra-r16 ENUMERATED {gap, no-gap}
}
NeedForGapsNR-r16 ::= SEQUENCE (
  bandNR-r16 FreqBandIndicatorNR,
  gapIndication-r16 ENUMERATED {gap, no-gap)
}
-- TAG-NeedForGapsInfoNR-STOP
-- ASN1STOP
```

The IE NeedForGapNCSG-ConfigNR contains configuration related to the reporting of measurement gap and NCSG requirement information, as shown in Table 4.

TABLE 4
NeedForGapNCSG-ConfigNR information element

```
-- ASN1START
-- TAG-NEEDFORGAPNCSG-CONFIGNR-START
NeedForGapNCSG-ConfigNR-r17 ::= SEQUENCE {
  requestedTargetBandFilterNCSG-NR-r17 SEQUENCE (SIZE (1..maxBands)) OF
    FreqBandIndicatorNR OPTIONAL -- Need R
}
-- TAG-NEEDFORGAPNCSG-CONFIGNR-STOP
-- ASN1STOP
```

The IE NeedForGapNCSG-InfoNR indicates whether measurement gap or NCSG is required for the UE to perform SSB based measurements on an NR target band while NR-DC or NE-DC is not configured, as shown in Table 5.

TABLE 5
NeedForGapNCSG-InfoNR information element

```
-- ASN1START
-- TAG-NEEDFORGAPNCSG-INFONR-START
NeedForGapNCSG-InfoNR-r17 ::= SEQUENCE {
  intraFreq-needForNCSG-r17 NeedForNCSG-IntraFreqList-r17,
  interFreq-needForNCSG-r17 NeedForNCSG-BandListNR-r17
}
NeedForNCSG-IntraFreqList-r17 ::= SEQUENCE (SIZE (1.. maxNrofServingCells)) OF
    NeedForNCSG-IntraFreq-r17
NeedForNCSG-BandListNR-r17 ::= SEQUENCE (SIZE (1..maxBands)) OF NeedForNCSG-
    NR-r17
NeedForNCSG-IntraFreq-r17 ::= SEQUENCE {
  servCellId-r17 ServCellIndex,
  gapIndicationIntra-r17 ENUMERATED {gap, ncsg, nogap-noncsg}
}
NeedForNCSG-NR-r17 ::= SEQUENCE {
  bandNR-r17 FreqBandIndicatorNR,
  gapIndication-r17 ENUMERATED {gap, ncsg, nogap-noncsg}
}
-- TAG-NEEDFORGAPNCSG-INFONR-STOP
-- ASN1STOP
-- ASN1START
-- TAG-NEEDFORGAPNCSG-CONFIGNR-START
NeedForGapNCSG-ConfigNR-r17 ::= SEQUENCE {
  requestedTargetBandFilterNCSG-NR-r17 SEQUENCE (SIZE (1..maxBands)) OF
    FreqBandIndicatorNR OPTIONAL -- Need R
}
-- TAG-NEEDFORGAPNCSG-CONFIGNR-STOP
-- ASN1STOP
```

In some cases, there may exist the collision between interruptions for “gapless” measurements with potential PDCCH reception during connected mode DRX.

If an interruption, which is not a scheduling restriction period on the NW side, is colliding with a PDCCH occasion, especially during long DRX cycles, the device will lose the opportunity for UL and DL grants. If the PDCCH occasion is the only PDCCH occasion during the on-period of the long DRX period, the device is not reachable until next on-period of the DRX configuration.

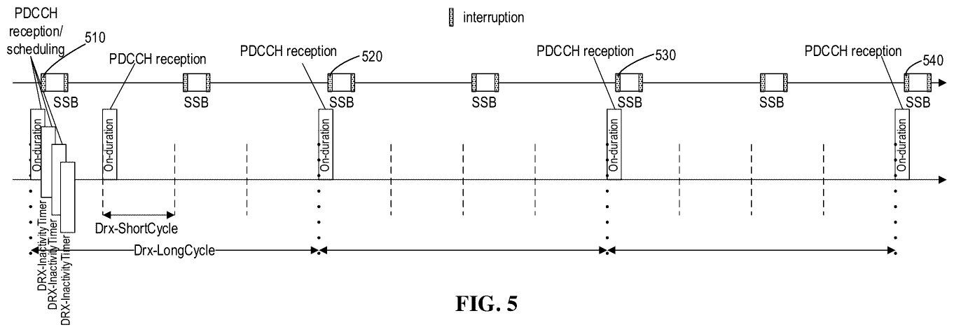

The problem is also actual in the case of the UE missing a PDCCH during the activity timer shown in FIG. 5. FIG. 5 shows an example of measurements with interruptions colliding with DRX on-duration time periods and in-activity time periods. As shown, the interruptions 510, 520, 530 and 540 collide with DRX on-duration time periods and in-activity time periods.

Moreover, the interruptions may also collide with short DRX cycle on duration periods, which thereby again conflicts with potential PDCCH monitoring.

### Work Principle and Example Signaling for Communication

According to some example embodiments of the present disclosure, there is provided a solution for collision handling for the interruptions and DRX operations. If a condition is fulfilled, the UE may determine on it own to shift an interruption in time domain to avoid the collision between the interruption and a DRX operation. Alternatively, or in addition, the gNB may configure the UE to perform the collision handling. In this way, conflicts between interruptions and on-duration/inactivity timer time periods under a set of circumstances can be avoided. In the following, the interruption may be also referred to as a communication interruption. As an example but without any limitation, the interruption may correspond to VIL.

Example embodiments of the present disclosure will be described in detail below with reference to the accompanying drawings.

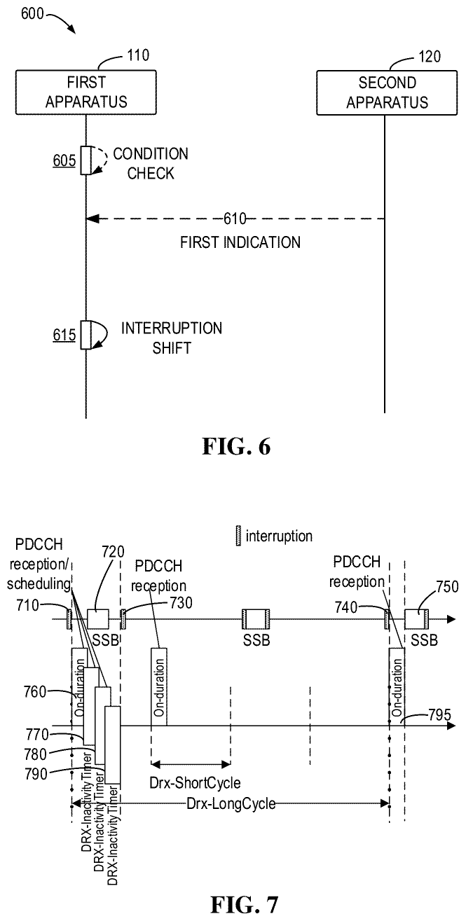

Reference is made to FIG. 6, which illustrates a signaling flow 600 in accordance with some embodiments of the present disclosure. For the purposes of discussion, the signaling flow 600 will be discussed with reference to FIG. 1, for example, by using the first apparatus 110, the second apparatus 120.

The first apparatus 110 may determine (605) whether a condition related to a communication interruption and a DRX operation for the first apparatus 110 is fulfilled. For example, the UE may determine whether a condition related to an interruption and the DRX operation is fulfilled. The one or more conditions or static rules define when the interruption is allowed to overlap with the on-duration/inactivity timer time periods and when not.

In some example embodiments, the condition may comprise that the communication interruption is overlapped at least partially in time domain with a control channel transmission occasion within an active time period of the DRX operation. The active time period of the DRX operation may include at least one of: an on-duration time period, or an extension of an on-duration time period as defined by an inactivity timer, which is also referred as inactivity timer time period, or an extension of an on-duration time period as defined by a DRX retransmission timer.

For example, the condition may include that the interruption is overlapped at least partially in time domain with a PDCCH occasion within the on-duration and/or inactivity timer time periods.

In some example embodiments, the condition may include that the communication interruption is overlapped at least partially in time domain with a control channel transmission occasion which is the last control channel transmission occasion within the active time period. For example, the condition may include that the interruption is overlapped at least partially in time domain with the last PDCCH occasion within the on-duration and/or inactivity timer time periods.

Alternatively, or in addition, in some example embodiments, the condition may include that the communication interruption is overlapped at least partially in time domain with an on-duration time period of the DRX operation and a duration of the on-duration time period is below a first threshold. For example, the condition may include that the communication interruption is overlapped at least partially in time with an on-duration time period and the on-duration time period is smaller than the first threshold. This means that if DRX on-duration is smaller than the first threshold, the communication interruption shall be moved not to overlap with the DRX on-duration.

Alternatively, or in addition, in some example embodiments, the condition may include that a ratio of a duration of the communication interruption to the duration of the on-duration time period is above a predefined ratio. For example, if a ratio of the length of the communication interruption to the length of the on-duration time period is above the predefined ratio, the interruption shall be moved in time domain.

Alternatively, or in addition, in some example embodiments, the condition may include that a duration of a long DRX cycle of the DRX operation exceeds a second threshold. For example, if the long DRX cycle is longer that the second threshold, the colliding communication interruption shall be moved in time domain.

It is noted that the above conditions are given as examples without any limitation. Any combination of the above example conditions is possible.

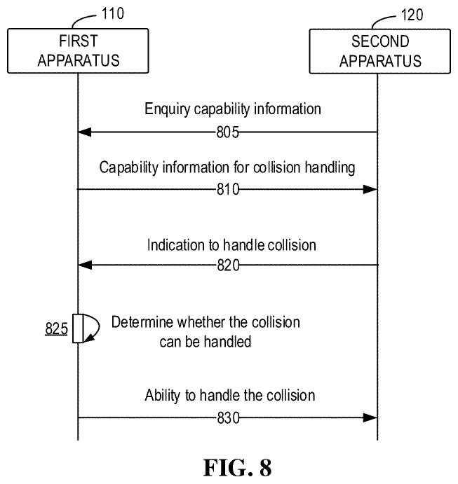

Alternatively, or in addition, in some example embodiments, the first apparatus 110 may receive (610), from a second apparatus 120, a first indication to handle a collision between the communication interruption and the DRX operation is received from a second apparatus. This may mean that the first apparatus 110 and the second apparatus 120 may negotiate the resolution of the collisions. Such example embodiments will be described in detail with reference to FIG. 8.

If the condition is fulfilled or the first indication is received, the first apparatus 110 shifts (615) the communication interruption in time domain. In other words, the location of the colliding communication interruption in time domain may be changed.

Otherwise, if the condition is not fulfilled and the first indication is not received, the first apparatus 110 may not shift the communication interruption in time domain.

In some example embodiments, the shifted communication interruption is not overlapped with an active time period of the DRX operation in time domain. For example, after shifting, the communication interruption is no longer overlapped with the on-duration time periods and the inactivity timer time periods.

Reference is now made to FIG. 7. As shown, the interruption 710 is moved to be located before the on duration time period 760 of the first long DRX cycle and the interruption 730 after the SSB measurement length 720 is moved to after the last inactivity timer period 790. Thereby, there is no conflicts between PDCCH monitoring and interruptions. Similarly, the interruption 740 is moved to be located before the on duration time period 795 of the second long DRX cycle.

In some example embodiments, the shifted communication interruption is not overlapped with the last control channel transmission occasion within an active time period of the DRX operation in time domain. For example, the interruption after being shifted is not overlapped with the last PDCCH occasion within the active time period.

In some example embodiments, if the communication interruption precedes a measurement length time period, the first apparatus 110 may shift the communication interruption forward in time domain such that the active time period starts after the end of the communication interruption. For example, the interruption 710 precedes the SSB measurement length 720 and thus is shifted forward in time domain such that the on duration time period 760 starts after the end of the interruption 710. For another example, the interruption 740 precedes the SSB measurement length 750 and thus is shifted forward in time domain such that the on duration time period 795 starts after the end of the interruption 740.

In some example embodiments, if the communication interruption succeeds a measurement length time period, the first apparatus 110 may shift the communication interruption backward in time domain such that the communication interruption starts after the end of the active time period. For example, the interruption 730 succeeds the SSB measurement length 720 and thus is shifted backward such that the interruption 730 starts after the end of all the on duration time period 760, the inactivity timer time periods 770, 780, 790.

In some example embodiments, the UE may report its interruption capability to the gNB and the gNB may configure the UE for collision handing similarly as the above mentioned condition or static rule but also taking the UE reported interruption capability into consideration. In other words, in the example embodiments based on signaling, the UE can report the capability to move interruptions for connected mode DRX and the network can configure the UE to move interruptions based on the reported capability.

Reference is now made to FIG. 8, which illustrates a signaling flow 800 for configuring collision handling according to some example embodiments of the present disclosure.

In some example embodiments, the first apparatus 110 and the second apparatus 120 may exchange the capability of the first apparatus 110 being able to handle parallel connected DRX and interruption periods. As shown, the second apparatus 120 may enquiry (805) capability information to the first apparatus 110. For example, the UECapablityEnquiry message may be transmitted to the first apparatus 110.

In response, the first apparatus 110 may then transmit (810), to the second apparatus 120, capability information indicating a capability of the first apparatus 110 for collision handling associated with measurement gaps and control channel transmissions. For example, the first apparatus 110 may transmit the UECapablityInformation message to the second apparatus 120 and indicate in the message of its ability to handle parallel connected DRX and interruption periods.

In some example embodiments, the capability information may indicate that the collision handling is supported by the first apparatus 110, for example, that the UE has the capability to avoid collision between interruptions and DRX active time period. Alternatively, or in addition, the capability information may indicate a communication interruption duration, for example, interruption length. Alternatively, or in addition, the capability information may indicate the maximum number of control channel transmission occasions for which collision handling can be applied, for example, the maximum number of PDCCH occasion for which collision can be avoided.

In some example embodiments, the second apparatus 120 may determine whether a condition related to a communication interruption and a DRX operation for the first apparatus is fulfilled. The condition is similar as that described with reference to FIG. 6. If the condition is fulfilled, the second apparatus 120 may transmit (820), to the first apparatus 110, a first indication to handle a collision between the communication interruption and the DRX operation. For example, the second apparatus 120 may transmit a RRC Reconfiguration message to the first apparatus 110 and the RRC Reconfiguration message may include the IE needForGapNCSG or similar, and include a configuration to move interruptions in case there is a conflict with connected mode-DRX (C-DRX) active time periods.

If the condition is not fulfilled, the second apparatus 120 may not transmit the first indication to the first apparatus 110. In other words, the second apparatus 120 may not indicate the first apparatus 110 to shift the communication interruption in time domain.

In some example embodiments, whenever a configuration is given to the first apparatus 110, the first apparatus 110 will establish the need for potential interruptions due to the measurements.

Specifically, as shown, the first apparatus 110 may determine (825), based on the first indication from the second apparatus 120 and the capability of the first apparatus 110, whether the first apparatus 110 is able to handle the collision between the communication interruption and the DRX operation. For example, the first apparatus 110 may then evaluate the configuration from the second apparatus 120 and establish whether it is capable of handling interruptions overlapping with C-DRX active time periods.

The first apparatus 110 may transmit (830), to the second apparatus 120, a second indication of its ability to handle the collision. The second indication may be included in any suitable signaling.

In some example embodiment, the first apparatus 110 may transmit, to the second apparatus 120, a UE assistance information message indicating its ability to handle parallel activities, for example, an interruption in parallel to C-DRX active time periods.

In some example embodiments, the first apparatus 110 may transmit, to the second apparatus 120, a RRC reconfiguration Complete message. The RRC reconfiguration Complete message may include the IE needForGapNCSGInfo and further indicate the ability to handle parallel activities, for example, interruptions in parallel to C-DRX periods. For example, if the first indication is comprised in the RRC Reconfiguration message, and the second indication may be comprised in an RRC reconfiguration complete message.

In this way, the collision between communication interruptions with potential PDCCH reception during connected mode DRX can be avoided. Thus, the UE can be facilitated not to miss control information from the network.

### Example Methods

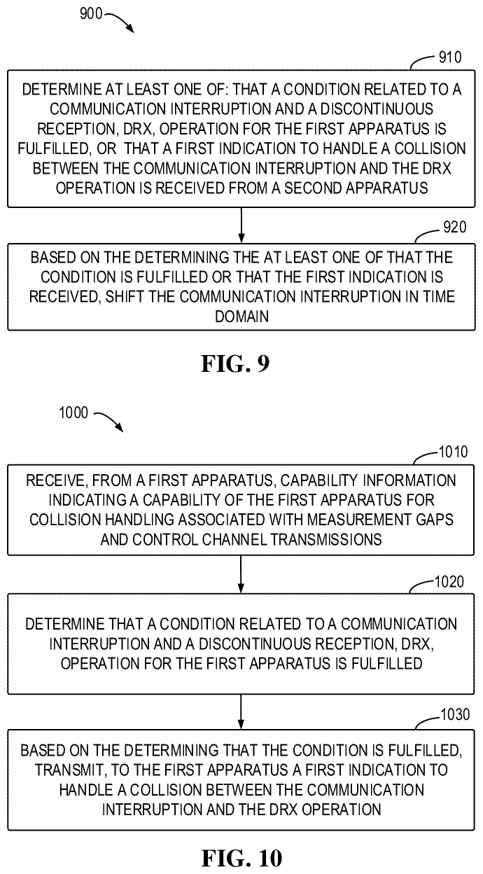

FIG. 9 shows a flowchart of an example method 900 implemented at a first apparatus in accordance with some example embodiments of the present disclosure. For the purpose of discussion, the method 900 will be described from the perspective of the first apparatus 110 in FIG. 1.

At block 910, the first apparatus 110 determines at least one of: that a condition related to a communication interruption and a discontinuous reception, DRX, operation for the first apparatus is fulfilled, or that a first indication to handle a collision between the communication interruption and the DRX operation is received from a second apparatus.

At block 920, based on the determining the at least one of that the condition is fulfilled or that the first indication is received, the first apparatus 110 shifts the communication interruption in time domain.

In some example embodiments, the condition comprises at least one of: the communication interruption is overlapped at least partially in time domain with a control channel transmission occasion within an active time period of the DRX operation, the communication interruption is overlapped at least partially in time domain with an on-duration time period of the DRX operation and a duration of the on-duration time period is below a first threshold, a ratio of a duration of the communication interruption to the duration of the on-duration time period is above a predefined ratio, or a duration of a long DRX cycle of the DRX operation exceeds a second threshold.

In some example embodiments, the communication interruption is overlapped at least partially in time domain with a control channel transmission occasion which is the last control channel transmission occasion within the active time period.

In some example embodiments, the shifted communication interruption is not overlapped with an active time period of the DRX operation in time domain.

In some example embodiments, the shifted communication interruption is not overlapped with the last control channel transmission occasion within an active time period of the DRX operation in time domain.

In some example embodiments, the communication interruption precedes a measurement length time period. The method 900 may further comprise: shifting the communication interruption forward in time domain such that the active time period starts after the end of the communication interruption.

In some example embodiments, the communication interruption succeeds a measurement length time period. The method 900 may further comprise: shifting the communication interruption backward in time domain such that the communication interruption starts after the end of the active time period.

In some example embodiments, the active time period comprises at least one of: an on-duration time period, or an extension of an on-duration time period as defined by an inactivity timer, or an extension of an on-duration time period as defined by a DRX retransmission timer.

In some example embodiments, the method 900 may further comprise: transmitting, to the second apparatus, capability information indicating a capability of the first apparatus for collision handling associated with measurement gaps and control channel transmissions; and receiving the first indication from the second apparatus.

In some example embodiments, the method 900 may further comprise: determining, based on the first indication from the second apparatus and the capability of the first apparatus, that the first apparatus is able to handle the collision between the communication interruption and the DRX operation; and based on the determining that the first apparatus is able to handle the collision, shifting the communication interruption in time domain based on the first indication.

In some example embodiments, the method 900 may further comprise: transmitting, to the second apparatus, a second indication of the ability to handle the collision.

In some example embodiments, the first indication is comprised in a radio resource control, RRC, reconfiguration message, and the second indication is comprised in an RRC reconfiguration complete message.

In some example embodiments, the capability information indicates at least one of: that the collision handling is supported by the first apparatus, a communication interruption duration, or the maximum number of control channel transmission occasions for which collision handling can be applied.

FIG. 10 shows a flowchart of an example method 1000 implemented at a second apparatus in accordance with some example embodiments of the present disclosure. For the purpose of discussion, the method 1000 will be described from the perspective of the second apparatus 120 in FIG. 1.

At block 1010, the second apparatus 120 receives, from a first apparatus, capability information indicating a capability of the first apparatus for collision handling associated with measurement gaps and control channel transmissions.

At block 1020, the second apparatus 120 determines that a condition related to a communication interruption and a discontinuous reception, DRX, operation for the first apparatus is fulfilled.

At block 1030, based on the determining that the condition is fulfilled, the second apparatus 120 transmits, to the first apparatus a first indication to handle a collision between the communication interruption and the DRX operation.

In some example embodiments, the condition comprises at least one of: the communication interruption is overlapped at least partially in time domain with a control channel transmission occasion within an active time period of the DRX operation, the communication interruption is overlapped at least partially in time domain with an on-duration time period of the DRX operation and a duration of the on-duration time period is below a first threshold, a ratio of a duration of the communication interruption to the duration of the on-duration time period is above a predefined ratio, or a duration of a long DRX cycle of the DRX operation exceeds a second threshold.

In some example embodiments, the communication interruption is overlapped at least partially in time domain with a control channel transmission occasion which is the last control channel transmission occasion within the active time period.

In some example embodiments, the instructions, when executed by the at least one processor, cause the second apparatus to: receiving, from the first apparatus, a second indication of the ability to handle the collision.

In some example embodiments, the first indication is comprised in a radio resource control, RRC, reconfiguration message, and the second indication is comprised in an RRC reconfiguration complete message.

In some example embodiments, the capability information indicates at least one of: that the collision handling is supported by the first apparatus, a communication interruption duration, or the maximum number of control channel transmission occasions for which collision handling can be applied.

### Example Apparatus, Device and Medium

In some example embodiments, a first apparatus capable of performing any of the method 900 (for example, the first apparatus 110 in FIG. 1) may comprise means for performing the respective operations of the method 900. The means may be implemented in any suitable form. For example, the means may be implemented in a circuitry or software module. The first apparatus may be implemented as or included in the first apparatus 110 in FIG. 1.

In some example embodiments, the first apparatus comprises means for determining at least one of: that a condition related to a communication interruption and a discontinuous reception, DRX, operation for the first apparatus is fulfilled, or that a first indication to handle a collision between the communication interruption and the DRX operation is received from a second apparatus; and means for, based on the determining the at least one of that the condition is fulfilled or that the first indication is received, shifting the communication interruption in time domain.

In some example embodiments, the condition comprises at least one of: the communication interruption is overlapped at least partially in time domain with a control channel transmission occasion within an active time period of the DRX operation, the communication interruption is overlapped at least partially in time domain with an on-duration time period of the DRX operation and a duration of the on-duration time period is below a first threshold, a ratio of a duration of the communication interruption to the duration of the on-duration time period is above a predefined ratio, or a duration of a long DRX cycle of the DRX operation exceeds a second threshold.

In some example embodiments, the communication interruption is overlapped at least partially in time domain with a control channel transmission occasion which is the last control channel transmission occasion within the active time period.

In some example embodiments, the shifted communication interruption is not overlapped with an active time period of the DRX operation in time domain.

In some example embodiments, the shifted communication interruption is not overlapped with the last control channel transmission occasion within an active time period of the DRX operation in time domain.

In some example embodiments, the communication interruption precedes a measurement length time period. The first apparatus may further comprise: means for shifting the communication interruption forward in time domain such that the active time period starts after the end of the communication interruption.

In some example embodiments, the communication interruption succeeds a measurement length time period. The first apparatus may further comprise: means for shifting the communication interruption backward in time domain such that the communication interruption starts after the end of the active time period.

In some example embodiments, the active time period comprises at least one of: an on-duration time period, or an extension of an on-duration time period as defined by an inactivity timer, or an extension of an on-duration time period as defined by a DRX retransmission timer.

In some example embodiments, the first apparatus may further comprise: means for transmitting, to the second apparatus, capability information indicating a capability of the first apparatus for collision handling associated with measurement gaps and control channel transmissions; and means for receiving the first indication from the second apparatus.

In some example embodiments, the first apparatus may further comprise: means for determining, based on the first indication from the second apparatus and the capability of the first apparatus, that the first apparatus is able to handle the collision between the communication interruption and the DRX operation; and means for, based on the determining that the first apparatus is able to handle the collision, shifting the communication interruption in time domain based on the first indication.

In some example embodiments, the first apparatus may further comprise: means for transmitting, to the second apparatus, a second indication of the ability to handle the collision.

In some example embodiments, the first indication is comprised in a radio resource control, RRC, reconfiguration message, and the second indication is comprised in an RRC reconfiguration complete message.

In some example embodiments, the capability information indicates at least one of: that the collision handling is supported by the first apparatus, a communication interruption duration, or the maximum number of control channel transmission occasions for which collision handling can be applied.

In some example embodiments, the first apparatus further comprises means for performing other operations in some example embodiments of the method 900 or the first apparatus 110. In some example embodiments, the means comprises at least one processor; and at least one memory storing instructions that, when executed by the at least one processor, cause the performance of the first apparatus.

In some example embodiments, a second apparatus capable of performing any of the method 1000 (for example, the second apparatus 120 in FIG. 1) may comprise means for performing the respective operations of the method 1000. The means may be implemented in any suitable form. For example, the means may be implemented in a circuitry or software module. The second apparatus may be implemented as or included in the second apparatus 120 in FIG. 1.

In some example embodiments, the second apparatus comprises means for receiving, from a first apparatus, capability information indicating a capability of the first apparatus for collision handling associated with measurement gaps and control channel transmissions; means for determining that a condition related to a communication interruption and a discontinuous reception, DRX, operation for the first apparatus is fulfilled; and means for, based on the determining that the condition is fulfilled, transmitting, to the first apparatus a first indication to handle a collision between the communication interruption and the DRX operation.

In some example embodiments, the condition comprises at least one of: the communication interruption is overlapped at least partially in time domain with a control channel transmission occasion within an active time period of the DRX operation, the communication interruption is overlapped at least partially in time domain with an on-duration time period of the DRX operation and a duration of the on-duration time period is below a first threshold, a ratio of a duration of the communication interruption to the duration of the on-duration time period is above a predefined ratio, or a duration of a long DRX cycle of the DRX operation exceeds a second threshold.

In some example embodiments, the communication interruption is overlapped at least partially in time domain with a control channel transmission occasion which is the last control channel transmission occasion within the active time period.

In some example embodiments, the instructions, when executed by the at least one processor, cause the second apparatus to: means for receiving, from the first apparatus, a second indication of the ability to handle the collision.

In some example embodiments, the first indication is comprised in a radio resource control, RRC, reconfiguration message, and the second indication is comprised in an RRC reconfiguration complete message.

In some example embodiments, the capability information indicates at least one of: that the collision handling is supported by the first apparatus, a communication interruption duration, or the maximum number of control channel transmission occasions for which collision handling can be applied.

In some example embodiments, the second apparatus further comprises means for performing other operations in some example embodiments of the method 1000 or the second apparatus 120. In some example embodiments, the means comprises at least one processor; and at least one memory storing instructions that, when executed by the at least one processor, cause the performance of the second apparatus.

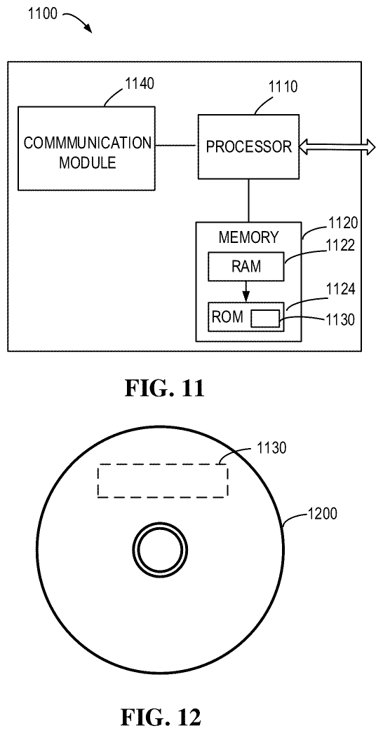

FIG. 11 is a simplified block diagram of a device 1100 that is suitable for implementing example embodiments of the present disclosure. The device 1100 may be provided to implement a communication device, for example, the first apparatus 110 or the second apparatus 120 as shown in FIG. 1. As shown, the device 1100 includes one or more processors 1110, one or more memories 1120 coupled to the processor 1110, and one or more communication modules 1140 coupled to the processor 1110.

The communication module 1140 is for bidirectional communications. The communication module 1140 has one or more communication interfaces to facilitate communication with one or more other modules or devices. The communication interfaces may represent any interface that is necessary for communication with other network elements. In some example embodiments, the communication module 1140 may include at least one antenna.

The processor 1110 may be of any type suitable to the local technical network and may include one or more of the following: general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

The memory 1120 may include one or more non-volatile memories and one or more volatile memories. Examples of the non-volatile memories include, but are not limited to, a Read Only Memory (ROM) 1124, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 1122 and other volatile memories that will not last in the power-down duration.

A computer program 1130 includes computer executable instructions that are executed by the associated processor 1110. The instructions of the program 1130 may include instructions for performing operations/acts of some example embodiments of the present disclosure. The program 1130 may be stored in the memory, e.g., the ROM 1124. The processor 1110 may perform any suitable actions and processing by loading the program 1130 into the RAM 1122.

The example embodiments of the present disclosure may be implemented by means of the program 1130 so that the device 1100 may perform any process of the disclosure as discussed with reference to FIG. 2 to FIG. 10. The example embodiments of the present disclosure may also be implemented by hardware or by a combination of software and hardware.

In some example embodiments, the program 1130 may be tangibly contained in a computer readable medium which may be included in the device 1100 (such as in the memory 1120) or other storage devices that are accessible by the device 1100. The device 1100 may load the program 1130 from the computer readable medium to the RAM 1122 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 12 shows an example of the computer readable medium 1200 which may be in form of CD, DVD or other optical storage disk. The computer readable medium 1200 has the program 1130 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1.-24. (canceled)

25. A first apparatus comprising:
at least one processor; and
at least one memory storing instructions that, when executed by the at least one processor, cause the first apparatus to:
determine the following:
that conditions related to a communication interruption and a discontinuous reception (DRX) operation for the first apparatus are fulfilled, wherein the conditions comprises the following: the communication interruption is overlapped at least partially in time domain with a control channel transmission occasion within an active time period of the DRX operation, the communication interruption is overlapped at least partially in time domain with an on-duration time period of the DRX operation and a duration of the on-duration time period is below a first threshold, a ratio of a duration of the communication interruption to the duration of the on-duration time period is above a predefined ratio, and a duration of a long DRX cycle of the DRX operation exceeds a second threshold; and
that a first indication to handle a collision between the communication interruption and the DRX operation is received from a second apparatus;
transmit, to the second apparatus, capability information indicating a capability of the first apparatus for collision handling associated with measurement gaps and control channel transmissions, the capability information indicating the following: that the collision handling is supported by the first apparatus, a communication interruption duration, and a maximum number of control channel transmission occasions for which collision handling can be applied;
determine, based on the first indication from the second apparatus and the capability of the first apparatus, that the first apparatus is able to handle the collision between the communication interruption and the DRX operation; and
based on the determining that the conditions are met and that the first apparatus is able to handle the collision, shift the communication interruption in time domain based on the first indication.

26. The first apparatus of claim 25, wherein the shifted communication interruption is not overlapped with an active time period of the DRX operation in time domain.

27. The first apparatus of claim 25, wherein the shifted communication interruption is not overlapped with a last control channel transmission occasion within an active time period of the DRX operation in time domain.

28. The first apparatus of claim 27, wherein the communication interruption precedes a measurement length time period, and the instructions, when executed by the at least one processor, cause the first apparatus to:
shift the communication interruption forward in time domain such that the active time period starts after an end of the communication interruption.

29. The first apparatus of claim 27, wherein the communication interruption succeeds a measurement length time period, and the instructions, when executed by the at least one processor, cause the first apparatus to:
shift the communication interruption backward in time domain such that the communication interruption starts after an end of the active time period.

30. The first apparatus of claim 29, wherein the active time period comprises an on-duration time period.

31. The first apparatus of claim 29, wherein the active time period comprises one of an extension of an on-duration time period as defined by an inactivity timer; or an extension of an on-duration time period as defined by a DRX retransmission timer.

32. A system comprising:
a first apparatus:
at least one processor; and
at least one memory storing instructions that, when executed by the at least one processor, cause the first apparatus to:
determine the following:
that conditions related to a communication interruption and a discontinuous reception (DRX) operation for the first apparatus are fulfilled, wherein the conditions comprises the following: the communication interruption is overlapped at least partially in time domain with a control channel transmission occasion within an active time period of the DRX operation, the communication interruption is overlapped at least partially in time domain with an on-duration time period of the DRX operation and a duration of the on-duration time period is below a first threshold, a ratio of a duration of the communication interruption to the duration of the on-duration time period is above a predefined ratio, and a duration of a long DRX cycle of the DRX operation exceeds a second threshold; and
that a first indication to handle a collision between the communication interruption and the DRX operation is received from a second apparatus;
transmit, to the second apparatus, capability information indicating a capability of the first apparatus for collision handling associated with measurement gaps and control channel transmissions, the capability information indicating the following: that the collision handling is supported by the first apparatus, a communication interruption duration, and a maximum number of control channel transmission occasions for which collision handling can be applied;
determine, based on the first indication from the second apparatus and the capability of the first apparatus, that the first apparatus is able to handle the collision between the communication interruption and the DRX operation; and
based on the determining that the conditions are met and that the first apparatus is able to handle the collision, shift the communication interruption in time domain based on the first indication.

33. The system of claim 32, wherein the shifted communication interruption is not overlapped with an active time period of the DRX operation in time domain.

34. The system of claim 32, wherein the shifted communication interruption is not overlapped with a last control channel transmission occasion within an active time period of the DRX operation in time domain.

35. The system of claim 34, wherein the communication interruption precedes a measurement length time period, and the instructions, when executed by the at least one processor, cause the first apparatus to:
shift the communication interruption forward in time domain such that the active time period starts after an end of the communication interruption.

36. The system of claim 34, wherein the communication interruption succeeds a measurement length time period, and the instructions, when executed by the at least one processor, cause the first apparatus to:
shift the communication interruption backward in time domain such that the communication interruption starts after an end of the active time period.

37. The system of claim 36, wherein the active time period comprises an on-duration time period.

38. The system of claim 37, wherein the active time period comprises one of an extension of an on-duration time period as defined by an inactivity timer; or an extension of an on-duration time period as defined by a DRX retransmission timer.

39. A method comprising:
determining, by a first apparatus, the following:
that conditions related to a communication interruption and a discontinuous reception (DRX) operation for the first apparatus are fulfilled, wherein the conditions comprises the following: the communication interruption is overlapped at least partially in time domain with a control channel transmission occasion within an active time period of the DRX operation, the communication interruption is overlapped at least partially in time domain with an on-duration time period of the DRX operation and a duration of the on-duration time period is below a first threshold, a ratio of a duration of the communication interruption to the duration of the on-duration time period is above a predefined ratio, and a duration of a long DRX cycle of the DRX operation exceeds a second threshold; and
that a first indication to handle a collision between the communication interruption and the DRX operation is received from a second apparatus;
transmitting, to the second apparatus, capability information indicating a capability of the first apparatus for collision handling associated with measurement gaps and control channel transmissions, the capability information indicating the following: that the collision handling is supported by the first apparatus, a communication interruption duration, and a maximum number of control channel transmission occasions for which collision handling can be applied;
determining, based on the first indication from the second apparatus and the capability of the first apparatus, that the first apparatus is able to handle the collision between the communication interruption and the DRX operation; and
based on the determining that the conditions are met and that the first apparatus is able to handle the collision, shifting the communication interruption in time domain based on the first indication.

40. The method of claim 39, wherein the shifted communication interruption is not overlapped with an active time period of the DRX operation in time domain.

41. The method of claim 39, wherein the shifted communication interruption is not overlapped with a last control channel transmission occasion within an active time period of the DRX operation in time domain.

42. The method of claim 41, wherein the communication interruption precedes a measurement length time period, and wherein the method further comprises:
shifting the communication interruption forward in time domain such that the active time period starts after an end of the communication interruption.

43. The method of claim 41, wherein the communication interruption succeeds a measurement length time period, and wherein the method further comprises:
shifting the communication interruption backward in time domain such that the communication interruption starts after an end of the active time period.

44. The method of claim 43, wherein the active time period comprises one of an on-duration time period, an extension of an on-duration time period as defined by an inactivity timer; or an extension of an on-duration time period as defined by a DRX retransmission timer.
